(19) United States
(12) Patent Application Publication
(10) Pub. No.: US 2021/0154959 A1
(43) Pub. Date: May 27, 2021

(54) ROTARY TABLET PRESS AND TABLET OUTLET THEREFOR

(71) Applicant: Romaco Kilian GmbH, köln (DE)

(72) Inventors: Jens Carstens, Leverkusen (DE); Martin Baska, Köln (DE); Waldemar Ruff, Leverkusen (DE)

(21) Appl. No.: 16/610,554

(22) PCT Filed: May 3, 2018
(86) PCT No.: PCT/IB2018/053080

§ 371 Date: Nov. 4, 2019

(30) Foreign Application Priority Data
May 3, 2017 (DE) 20 2017 102 635.3

(51) Int. Cl. B30B 11/00; B30B 11/08

(52) U.S. Cl. CPC B30B 11/005; B30B 15/32; B30B 11/08

(57) ABSTRACT

A rotary tablet press including a rotor which has a die plate for producing tablets inside die openings by means of press punch pairs, and with a discharge device being assigned to a tablet outlet for supplying tablets either singulated to a first tablet channel or as a tablet stream to a second tablet channel, wherein the tablet outlet has at least one first outlet channel for good tablets and a second outlet channel for faulty tablets, the first and/or the second tablet channel have at least one channel through-passage enclosed by lateral boundaries, wherein a sensor device which is coupled to the process control device and which is configured for scanning the entire cross section of the channel through-passage is assigned thereto for generating a sensor signal when a body passes through the associated channel through-passage.

This Application claims priority in International Application No. PCT/IB2018/053080 that was filed on May 3, 2018, which claims priority in DE No. 20 2017 102 635.3 that was filed on May 3, 2017, both of which are incorporated by reference into this application.

The invention relates to a rotary tablet press comprising a rotor which is able to be driven about a vertical rotational axis and which has a die plate with die openings for producing tablets inside the die openings by means of press punch pairs, comprising at least one pressing station for applying a pressing force onto the press punches of the press punch pairs and comprising at least one tablet outlet for discharging the produced tablets from the rotary tablet press, a discharge device being assigned to the tablet outlet, with which according to a control signal of a process control device tablets being able to be supplied singulated to a first tablet channel via a first inlet opening or as a tablet stream to a second tablet channel via a second inlet opening in the tablet outlet, wherein the tablet outlet comprises at least one first outlet channel for good tablets and a second outlet channel for faulty tablets. The invention further relates to a tablet outlet for a rotary tablet press comprising a die plate with die openings for producing tablets in the die openings, having a first tablet channel with a first inlet opening and having a second tablet channel with a second inlet opening in the tablet outlet separate from the first inlet opening, wherein according to a control signal to a discharge device of the rotary tablet press, tablets are able to be supplied in singulated manner to the first tablet channel via the first inlet opening or as a tablet stream to the second tablet channel via the second inlet opening, with a first outlet channel for good tablets and with a second outlet channel for faulty tablets.

### BACKGROUND OF THE INVENTION

With rotary tablet presses it is now possible to produce exceptionally high production outputs with more than 1.5 million tablets per hour. The production process is carried out on almost all tablet presses such that the lower punch of the punch pair is moved downwardly in order to produce in the die openings of the die plate a cavity which in a filling unit, for example, is filled with powder or granulate to the desired quantity, wherein subsequently the upper and the lower punch of the punch pair are pressed together in a controlled manner in a pressing station, before both punches are lifted by means of the control cams controlling the movement thereof and the tablets thus produced are discharged from the tablet press by means of the discharge device and the tablet outlet and supplied to further processing stations, for example for deburring, sorting and packing. The production output in this case depends on numerous factors, such as for example the size of the tablets and the number of punch pairs. With rotary tablet presses, tablets may be produced for very different industrial sectors and uses, such as for example, detergent tablets for the detergent industry, stock cubes for the food industry, effervescent tablets for the drinks industry or pharmaceutical tablets for the pharmaceutical industry. In particular, in pharmaceuticals it has to be ensured that each tablet produced corresponds to the specifications with regard to weight, size and composition. Almost all rotary tablet presses, therefore, are provided with monitoring devices, wherein generally the pressing station is monitored and in the case of deviations in the applied pressing force, for example as the result of insufficient filling, a control signal is automatically generated to a singulating device inside a discharge device in order to discharge the faulty tablets separately. The separating singulation takes place in many rotary tablet presses via a pulse of air which is applied by means of a nozzle and the separating singulating device may also be used in order to withdraw sample tablets. A modern tablet outlet provides the possibility of supplying the tablet stream which consists of good tablets to the further production stations and at the same time diverting faulty tablets (reject tablets) and also supplying sample tablets for monitoring with regard to weight, size and composition. To this end, the tablet outlet generally has adjusting members such as deflectors, the outlet channel to which a specific tablet is supplied being influenced by the position thereof.

A generic rotary tablet press and an associated tablet outlet are disclosed in EP 1247640 B1. The singulation in the discharge device takes place by means of a pulse of compressed air which is exerted via a nozzle functioning as a discharge deflector and oriented toward the tablet to be discharged. In order to monitor a faulty function of the discharge deflector carrying out the singulation, a pressure sensor is arranged in the compressed air line of the nozzle downstream of a switchable valve, said pressure sensor producing a sensor signal when the valve connected to the compressed air line is opened and a predetermined minimum pressure is reached, wherein a fault signal is generated when the sensor signal is not detected within a predetermined time span after activating the valve.

A tablet outlet with a plurality of deflectors is disclosed in DE 102011050290 A1, wherein a weighing device with a batch measuring cell as a sensor is integrated in the tablet outlet.

It is known from DE 10 2007 043 581 A1 to provide an optical monitoring device in rotary tablet presses in the form of a high speed camera which is coupled to an image evaluation device inside the process control device in order to improve the monitoring of the production process by evaluation of the signals of the camera.

In particular in pharmaceutical tablets, extremely high requirements are set such that the specifications in all tablets are maintained in each batch produced. Should it arise that tablets are faulty within a specific batch or on a specific production day, the entire batch is not permitted to be sold or has to be recalled. In particular, in tablet outlets with a plurality of outlet channels which are controlled via deflectors, it has to be ensured that all deflectors are correctly positioned and function correctly and that also the discharge device, after receiving a control signal, has undertaken the discharge, for example, of a reject tablet.

### SUMMARY OF THE INVENTION

It is the object of the invention to improve the monitoring of the production process in rotary tablet presses and, in particular, to provide monitoring means in order to monitor the function of the discharge device and the deflectors during the course of the production process substantially simultaneously with the production of the respective tablets and as a result to reduce faulty production to a minimum.

To achieve this object, in a rotary tablet press the first and/or the second tablet channel have at least one channel through-passage enclosed by lateral boundaries, a sensor device coupled to the process control device and configured for scanning the entire cross section of the channel through-passage being assigned thereto for generating a sensor signal when a body passes through the associated channel through-passage. In a tablet outlet according to the invention it is provided that the first and/or the second tablet channel have at least one channel through-passage enclosed by lateral boundaries, a sensor device which is able to be coupled to the process control device and which is configured for scanning the entire cross section of the channel through-passage being assigned thereto for generating a sensor signal when a body passes through the channel through-passage. By the sensor device provided according to the invention in an enclosed channel through-passage it may be monitored whether, as a result of the control of the singulating device, a tablet actually leaves the tablet outlet within a predetermined timespan via the anticipated outlet channel. Since the entire cross section is monitored it is ensured that each passage through the channel through-passage is detected. Thus, at low cost in terms of technical control, both the adjusting members and the function of the singulating device may be monitored at the same time and namely with an extremely short time lag relative to the actual production process.

For achieving a minimum amount of monitoring according to one embodiment according to the invention, at least one sensor device is assigned to the outlet channel for faulty tablets. If during the production process due to an error message in the pressing station a control signal is generated for discharging a tablet as a faulty tablet, with the control signal a time window starts which is only closed when there is no error message, when within a preset timespan for the time window, with the sensor device assigned to the outlet channel for reject tablets, a passage of a body through the channel through-passage is detected and a corresponding sensor signal is generated. If, however, it leads to a deflection of the ejected reject tablet, for example due to a faulty position of one of the deflectors, due to a functional failure of the singulating device or for other reasons, the production process may be immediately stopped and thus the number of tablets within a batch to be ejected, in which it is not ensured whether all tablets in the batch satisfy the required specifications, may be reduced to a minimum.

The monitoring means and the accuracy thereof may be increased by at least one second sensor device being provided, said second sensor device being assigned to the inlet opening of the first tablet channel for faulty tablets. Both in the case of only one sensor device which is assigned to the outlet channel for reject tablets, and in the presence of at least two sensor devices, it is advantageous if an evaluation logic for the control signal and the sensor signal is implemented in the process control device, said evaluation logic activating a time window and generating a fault signal according to the control signal, when no sensor signal is generated by the sensor device within the time window. It is particularly expedient if in the case of a plurality of sensor devices a second evaluation logic is implemented in the process control device, said second evaluation logic, according to the sensor signal of a sensor device assigned to the first inlet opening, activating a second time window and generating a fault signal when no sensor signal is generated within the time window by a sensor device assigned to an outlet channel. The length of the time window is preferably able to be set in the process control device, wherein further preferably the duration of the time window may be controlled according to the speed of the die plate.

As known per se, according to a further advantageous embodiment, the tablet outlet may be provided with a sample outlet for sample tablets separately ejected by the discharge device, wherein preferably a further sensor device is assigned to the sample tablet outlet channel and/or wherein an adjusting member, in particular a deflector, is arranged downstream of the first inlet opening, the tablets which are able to be supplied via the first inlet opening being optionally able to be supplied thereby to the outlet channel for sample tablets or to the outlet channel for faulty tablets.

According to a particularly advantageous embodiment, an adjusting member in particular a deflector is arranged downstream of the second inlet opening in the tablet outlet, the tablets which are able to be supplied via the second inlet opening being optionally able to be supplied thereby to the outlet channel for good tablets or the outlet channel for faulty tablets. Alternatively or additionally, the discharge device may comprise a passive deflection rail assigned to the second inlet opening and a controllable nozzle assigned to the first inlet opening and connected to a compressed air line. The sensor devices according to the invention, however, may also be used in other discharge devices and singulating devices.

According to a particularly advantageous embodiment, in a rotary tablet press according to the invention, a counting logic may be implemented in the process control device, each sensor signal generated by one of the sensor devices being able to be detected separately thereby. This permits, in particular, when a separate sensor device is assigned to each outlet channel, and preferably in each case a separate sensor device is assigned to the least one inlet opening for the separated singulated tablets or even both inlet openings, the number of tablets actually emerging from the tablet outlet via the respective outlet channel to be counted and optionally to be compared with the number of tablets entering the tablet outlet via the two inlet openings, in order to permit a more detailed detection of the production process.

In principle, the sensor devices could be provided with different types of sensor. In the, in particular, preferred embodiment, at least one of the sensor devices provided according to the invention forms an optical sensor and/or is formed thereby, wherein preferably all sensor devices are optical sensors. However, it would also be possible to use electrical sensors, in particular inductive sensors, instead of optical sensors.

In the use of optical sensors it is advantageous, in particular, if the respective sensor device has an optical transmitting strip extending over the height and/or width of the channel through-passage, and a receiving strip for the optical transmitted signal of the transmitting strip, wherein preferably the transmitting strip is arranged so as to protrude over the one side of the channel through-passage and the receiving strip is arranged on the opposing side of the channel through-passage. It is particularly advantageous when a light curtain is able to be generated by the transmitting strip, said light curtain being detectable by the receiving strip in order to emit a sensor signal when the light curtain is partially interrupted. When a fault signal is detected in the process control device, a testing process may be started and/or the production process interrupted.

These and other objects, embodiments aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 shows a schematic view of a rotary tablet press according to the invention with a connected tablet outlet according to the invention, with a sensor device in the outlet channel for faulty tablets;

FIG. 2 shows schematically a sectional view through a channel through-passage of an outlet channel with the sensor device mounted;

FIG. 3 shows a tablet outlet according to a second exemplary embodiment with a plurality of sensor devices; and

FIG. 4 shows schematically, using a flow diagram, the possible monitoring and evaluation steps in the rotary tablet presses according to the invention.

### DESCRIPTION OF PREFERRED EMBODIMENTS

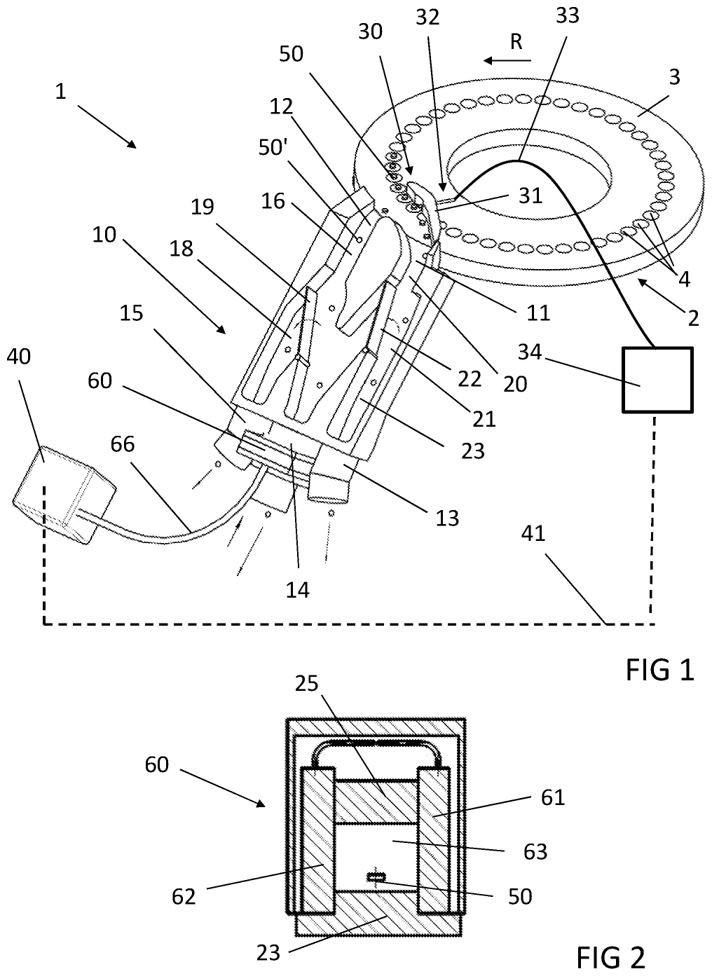

Referring now to the drawings wherein the showings are for the purpose of illustrating preferred and alternative embodiments of the invention only and not for the purpose of limiting the same, in FIG. 1, a rotary tablet press according to the invention with a rotor 2 is denoted overall by the reference numeral 1, however the die plate 3 with the die openings 4 configured in the die plate 3 is shown exclusively thereof as an essential component of the rotor. The press punch pairs located on the rotor 2 with an upper punch and a lower punch arranged in pairs and able to be moved up and down by control cams are shown to the same limited extent as the housing, the filling device, the drives or the pressing stations with pressing rollers, since the construction thereof is sufficiently known to the person skilled in the art and the design thereof is not essential to the invention.

The die plate 3 of the rotor 2 in this case has a total of 45 die openings and the tablets 50 produced in the die openings by the press punch pairs during the rotation of the rotor 2 are conducted away by means of a discharge device, denoted as a whole by the reference numeral 30, from the upper face of the die plate 3 and supplied to a tablet outlet 10 arranged in the rotational direction downstream of the pressing station. The discharge device 30 firstly comprises, in a manner known per se, a fixed and static deflection rail 31 by which all tablets 50 reaching the rail 31 are supplied as a tablet stream to the rear second inlet opening 11 of the tablet outlet 10, viewed in the rotational direction R, and further comprises a singulating device which in the exemplary embodiment shown, as known per se, consists of a nozzle 32 which, by activating a valve 34 and by being subjected to pressure via a compressed air line 33, produces a pulse of compressed air, by which individual tablets 50′ as faulty tablets (reject tablets) or sample tablets may be supplied to a first inlet opening 12 in the tablet outlet 10, wherein the first inlet opening 12, viewed in the rotational direction R of the rotor, is arranged upstream of the second inlet opening 11. The control signal for the valve 34 of the singulating device of the discharge device 30 is produced by a process control device 40 as a function of the punch, and then emitted via the activation line indicated by the line 41, for example when insufficient compression pressure has been detected in the pressing station in a punch pair, which in rotary tablet presses frequently serves as a reference value for a faulty tablet.

In the exemplary embodiment shown, the tablet outlet 10 has in addition to its two inlet openings 11, 12 three outlet channels separate from one another, namely a first outlet channel 13 for good tablets, a second outlet channel 14 for faulty tablets and a third outlet channel 15 for sample tablets. Downstream of the first inlet opening 12 the associated tablet channel 16 for faulty tablets and/or sample tablets is divided into a common supply portion 18 for the sample tablet outlet channel 15 and/or reject tablet outlet channel 14, wherein a first adjusting member formed by a deflector 19 is arranged in the supply portion 18. The outlet channel 14 and the outlet channel 15, therefore, also belong to the first tablet channel 16, to which tablets are supplied via the first inlet opening. Downstream of the second inlet opening 11 the associated tablet channel 20 for good tablets is divided into a common supply portion 21 for the outlet channel for good tablets 13 and/or for the outlet channel for reject tablets 14, wherein a second adjusting member formed by a further deflector 22 is arranged in the supply portion 21. The outlet channel 13 for good tablets thus also forms a part of the second tablet channel 20. FIG. 1 shows the positions of the deflectors 19, 22 in normal production, in which the majority of tablets are supplied to the outlet channel 13 as good tablets, whereas individual tablets as faulty tablets could be supplied to the outlet channel 14. The deflector 22 serves primarily to supply to the outlet channel 14 for faulty tablets the tablets which are produced during a start-up process of the tablet press, which generally do not yet fulfil all required specifications, which accumulate during the start-up process as a tablet stream and otherwise could be ejected only with difficulty by the singulating device or with additional effort.

The tablet outlet 10 is normally closed by means of a cover plate (not shown) which opposes the base 23 and which is generally transparent, which is why the tablets entering via one of the two inlet openings 11, 12 into the tablet outlet 10 have to leave this tablet outlet again via one of the outlet channels 13, 14, 15. The current position of the individual deflectors 19, 22 may be monitored by means of stop switches (not shown), which indicate when the respective end position of the deflectors 19, 22 of the control device 40 is reached. Since the individual tablets, however, pass at very high speeds through the respective tablet inlet 11, 12, and since the deflectors require freedom of movement relative to the base 23 and the cover plate, it may arise that individual tablets do not leave the tablet outlet or leave via an incorrect outlet channel.

In the exemplary embodiment shown, in FIG. 1, a sensor device 60 is assigned to the outlet channel 14 for faulty tablets, said sensor device being connected via a signal line 66 to the process control device 40. The signal line 60 preferably has a system plug which is able to be releasably coupled to corresponding system sockets in the control device 40. The sensor device 60 is shown schematically in FIG. 2 in detail and, so as to be able to be dismantled at the tablet outlet 14, may be inserted, for example, into a suitable sliding guide and anchored there. The sensor device 60 comprises in the exemplary embodiment shown an optical sensor with an optical transmitting strip 61 and an optical receiving strip 62. The transmitting strip 61 and the receiving strip 62 protrude from the base 23 of the tablet outlet and/or from the base of the outlet channel 14 and extend over the entire height of a channel through-passage 63 enclosed at the top, sides and bottom, wherein the upper boundary in this case is formed by a separate top wall 25. Since with the transmitting strip 61 and the receiving strip 62 the entire cross section of the channel through-passage 63 and thus the entire cross section of the outlet channel 14 is monitored, any through-passage of a body such as for example the faulty tablet 50′ shown, ensures a temporary interruption to the light signal arriving at the receiving strip 62, and this triggers a sensor signal which is emitted by the signal line 61 to the process control device 40.

The method of monitoring the production process in the tablet outlet 10 with a sensor device 60 integrated in the outlet channel 14 for faulty tablets is now described with additional reference to FIG. 4, in which the steps taking place during the monitoring or evaluation in an evaluation logic are shown in solid lines.

If a faulty tablet is identified by the process control device 40, with step S1 a control signal is generated to the singulating device of the discharge device (30, FIG. 1), in step S2 a time interval T1 being started as a function thereof. In step S3 over the duration of the time interval T1 it is monitored whether the sensor device (60, FIG. 1) has detected the passage of a body through the channel through-passage, (D1=1) or not (D1=0). The duration of the time interval T1 thus forms a time value which is either fixed due to empirical values for the specific tablet outlet or is deduced according to a predetermined function from the current production speed and thus primarily from the speed of the die plate. The number of dies and thus the number of press punch pairs and the rotational speed of the die plate have the greatest influence on the time value, and the timespan is approximately 1/3*1/n*1/m, where “n” equals the rotational speed and “m” equals the number of die openings. If during the time interval T1 a sensor signal D1 is detected (D1=1), the production process continues and is documented by step S5. If during the time interval T1 no sensor signal D1 is detected (D1=0) in step S4 either the production process is interrupted immediately or a monitoring process takes place.

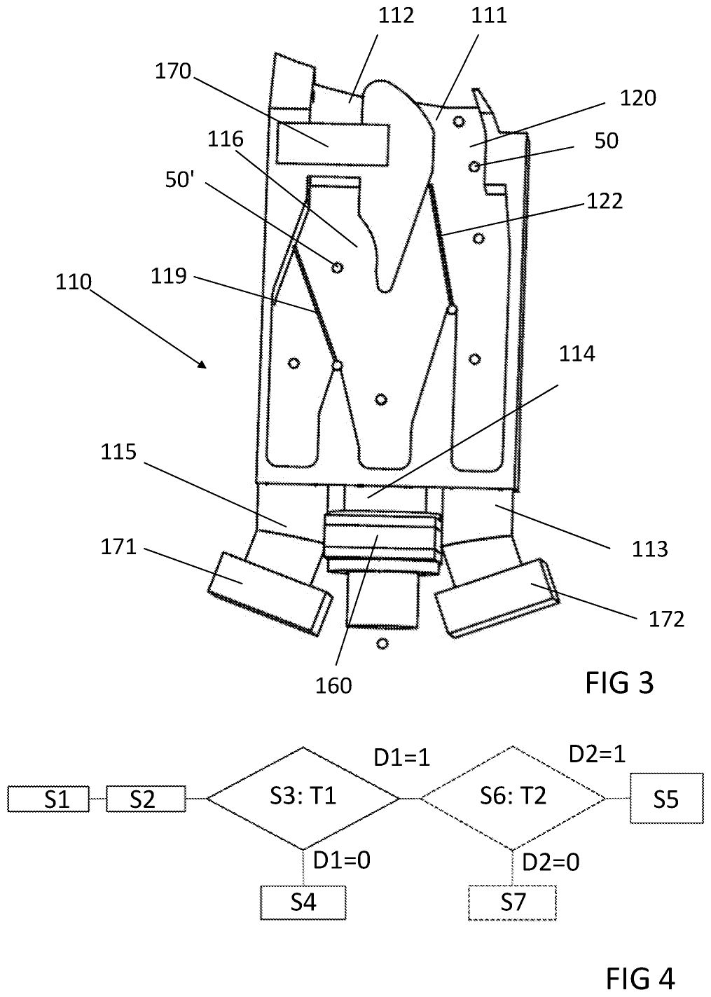

FIG. 3 shows an alternative exemplary embodiment of a tablet outlet 110. Components which are functionally the same are provided with reference numerals increased by 100 relative to the previous exemplary embodiment. The tablet outlet 110 has in turn two separate inlet openings 111, 112, wherein a deflector 119 is arranged downstream of the inlet opening 112 in order to supply the tablets 50′, which have been ejected separately, optionally to the outlet channel 115 for sample tablets or to the outlet channel 114 for faulty tablets. As in the previous exemplary embodiment, a deflector 122 is also arranged as an adjusting member downstream of the inlet opening 111 for good tablets, in order to supply the tablets 50 generally flowing in and sliding down as a tablet stream via this inlet opening 111 to the outlet channel 113 for good tablets, apart from when the deflector 122 is in the position pivoted to the right, not shown, whereby the tablets may also be supplied to the outlet channel 114 for reject tablets. Deviating from the previous exemplary embodiment, however, a plurality of sensor devices are provided here, namely a first sensor device 160 in the outlet channel 114 for faulty tablets and a second sensor device 170 in a channel portion of the tablet channel 116 directly downstream of the first inlet opening 112. In FIG. 3, moreover, it is indicated that when a tablet outlet is fully equipped a sensor device 171 may also be assigned to the outlet channel 115 for the sample tablets and a separate sensor device 172 may be assigned to the outlet channel 113 for the good tablets, wherein preferably all sensor devices 160, 170, 171, 172 have the same construction and, for example, the construction as has been described with reference to FIG. 2.

FIG. 4 shows, with the additional step shown in dashed lines, a further monitoring function with the presence of a sensor device 170 immediately downstream of the inlet opening 112 of the tablet channel 116. In the method sequence with a plurality of sensor devices, as a function of the control signal generated in step S2, in turn in step S3 a time interval T1 could be started which, however, waits for a sensor signal D1 of the sensor device 170 assigned to the inlet opening 111 and generates a fault signal when, in spite of the emitted control signal, nothing passes through the channel through-passage of the tablet channel 116; if a sensor signal is detected by the sensor device 170, this as indicated by step S6 may open a second time interval T2, which now waits for the sensor signal D of the sensor device 160 assigned to the outlet channel 114, if the causes for the sensor signal emitted by step S1 was the detection of a faulty tablet, or with the presence of a third sensor device 171 in the outlet channel of the sample outlet it is also possible to wait for a sensor signal of the sensor device 171, wherein when the anticipated sensor signal is absent with step S7 either the production process is stopped or a control process is initiated. With an additional sensor device 170 arranged downstream of the inlet opening 112 of the tablet channel 116 for the sample withdrawal and/or reject tablet withdrawal, all successively discharged tablets may also be counted by means of a suitable evaluation logic.

For the person skilled in the art, numerous modifications which are intended to fall within the protected scope of the claims are provided. The invention is not limited to the exemplary embodiment shown, which in any case primarily serves only for explaining the inventive idea. The singulation takes place here via a pulse of air but could also take place in a different manner. The optical sensor and/or the optical sensor device could be equipped with a calibration unit and a self-monitoring unit which displays that cleaning is required, for example, of the transmitting strip or receiving strip when the absorbed light output is attenuated to too great an extent and is below a reference value. Instead of a light fan, any other suitable flat light barrier could be produced with the transmitting strip or optical system, wherein it has to be ensured that the entire cross section of the channel through-passage is monitored.

Moreover, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A rotary tablet press comprising a rotor which is driveable about a vertical rotational axis and which has a die plate with die openings for producing tablets inside the die openings by means of press punch pairs, comprising at least one pressing station for applying a pressing force onto the press punches of the press punch pairs and comprising at least one tablet outlet for discharging the produced tablets from the rotary tablet press, with a discharge device being assigned to the tablet outlet, for supplying tablets in accordance with a control signal of a process control device singulated to a first tablet channel via a first inlet opening or as a tablet stream to a second tablet channel via a second inlet opening in the tablet outlet, wherein the tablet outlet comprises at least one first outlet channel for good tablets and a second outlet channel for faulty tablets, wherein the first and/or the second tablet channel have at least one channel through-passage enclosed by lateral boundaries, wherein a sensor device which is coupled to the process control device and which is configured for scanning the entire cross section of the channel through-passage is assigned thereto for generating a sensor signal when a body passes through the associated channel through-passage.

17. The tablet press according to claim 16, wherein a sensor device is assigned to the outlet channel for faulty tablets.

18. The tablet press according to claim 17, wherein at least one second sensor device is provided, said second sensor device being assigned to the inlet opening of the first tablet channel for faulty tablets.

19. The tablet press according to claim 17, wherein an evaluation logic for the control signal and the sensor signal is implemented in the process control device, said evaluation logic activating a time window and generating a fault signal according to the control signal when no sensor signal is generated by the sensor device within the time window.

20. The tablet press according to claim 19, wherein a second evaluation logic is implemented in the process control device, said second evaluation logic according to the sensor signal of a sensor device assigned to the first inlet opening activating a second time window and generating a fault signal when no sensor signal is generated within a time window by a sensor device assigned to an outlet channel.

21. The tablet press according to claim 19, wherein the length of the time window is able to be set in the process control device, wherein preferably the duration of the time window may be controlled according to the speed of the die plate.

22. The tablet press according to claim 17, wherein the tablet outlet is provided with a sample outlet for sample tablets separately ejected by the discharge device, wherein preferably a further sensor device is assigned to the sample tablet outlet channel, and/or wherein an adjusting member in particular a deflector, is arranged downstream of the first inlet opening, the tablets which are able to be supplied via the first inlet opening being optionally able to be supplied thereby to the outlet channel for sample tablets or to the outlet channel for faulty tablets.

23. The tablet press according to claim 16, wherein in the tablet outlet an adjusting member, in particular a deflector, is arranged downstream of the second inlet opening, the tablets which are able to be supplied via the second inlet opening being optionally able to be supplied thereby to the outlet channel for good tablets or to the outlet channel for faulty tablets.

24. The tablet press according to claim 16, wherein the discharge device comprises a passive deflection rail assigned to the second inlet opening and a controllable nozzle assigned to the first inlet opening and connected to a compressed air line.

25. The tablet press according to claim 16, wherein a counting logic is implemented in the process control device, each sensor signal generated by one of the sensor devices being able to be separately detected thereby.

26. The tablet press according to claim 16, wherein at least one sensor device is an optical sensor, wherein preferably all sensor devices are optical sensors.

27. The tablet press according to claim 26, wherein the sensor device has an optical transmitting strip extending over the height and/or width of the channel through-passage, and a receiving strip for the optical transmission signal of the transmitting strip, wherein preferably the transmitting strip is arranged so as to protrude over the one side of the channel through-passage and the receiving strip is arranged on the opposing side of the channel through-passage.

28. The tablet press according to claim 26, wherein a light curtain is able to be generated by the transmitting strip, said light curtain being detectable by the receiving strip in order to emit a sensor signal when the light curtain is partially interrupted.

29. The tablet press according to claim 16, wherein when detecting a fault signal in the process control device a testing process is started and/or the production process is interrupted.

30. A tablet outlet for a rotary tablet press comprising a die plate with a die opening for producing tablets in the die opening, comprising a first tablet channel with a first inlet opening, comprising a second tablet channel with a second inlet opening separated from the first inlet opening in the tablet outlet, wherein in accordance with control signal to a discharge device of the rotary tablet press tablets are supplyable singulated to the first tablet channel via the first inlet opening or as a tablet stream to the second tablet channel via the second inlet opening, comprising a first outlet channel for good tablets and comprising a second outlet channel for faulty tablets, wherein the first and/or the second tablet channel comprise at least one channel through-passage enclosed by lateral boundaries, wherein a sensor device which is able to be coupled to the process control device and which is configured to scanning the entire cross section of the channel through-passage is assigned thereto for generating a sensor signal when a body passes through the channel through-passage.

31. The tablet outlet according to claim 30, wherein a sensor device is assigned to the outlet channel for faulty tablets.

32. The tablet outlet according to claim 31, wherein at least one second sensor device is provided, said second sensor device being assigned to the inlet opening of the first tablet channel for faulty tablets.

33. The tablet outlet according to claim 31, wherein the tablet outlet is provided with a sample outlet for sample tablets separately ejected by the discharge device, wherein preferably a further sensor device is assigned to the sample tablet outlet channel, and/or wherein an adjusting member in particular a deflector, is arranged downstream of the first inlet opening, the tablets which are able to be supplied via the first inlet opening being optionally able to be supplied thereby to the outlet channel for sample tablets or to the outlet channel for faulty tablets.

34. The tablet outlet according to claim 30, wherein at least one sensor device is an optical sensor, wherein preferably all sensor devices are optical sensors.

35. The tablet outlet according to claim 34, wherein the sensor device has an optical transmitting strip extending over the height and/or width of the channel through-passage, and a receiving strip for the optical transmission signal of the transmitting strip, wherein preferably the transmitting strip is arranged so as to protrude over the one side of the channel through-passage and the receiving strip is arranged on the opposing side of the channel through-passage.

36. The tablet outlet according to claim 34, wherein a light curtain is able to be generated by the transmitting strip, said light curtain being detectable by the receiving strip in order to emit a sensor signal when the light curtain is partially interrupted.
